(19) United States
(12) Patent Application Publication
(10) Pub. No.: US 2006/0053022 A1
(43) Pub. Date: Mar. 9, 2006

(54) Www.hi22.com is easy to find and share local information for towns from around the world

(76) Inventor: David Min Yao, San Jose, CA (US)

Correspondence Address: David Min Yao, 1186 Somerset Drive, San Jose, CA, 95132, US

(21) Appl. No.: 10/933,914

(22) Filed: Sep. 3, 2004

(51) Int. Cl. G06Q 99/00

(52) U.S. Cl. 705/1; 705/26

(57) ABSTRACT

At www.hometowninteractive.com (www.hi22.com) it's easy to share and find local information. Towns from around the world are only a few mouse clicks away from each other. A system is set for the web surfers to go to any towns in the world very quickly, in a matter of seconds. Once the web surfer arrived at the chosen town then he/she can interact with the locals very easily. A web presence instant messenger such as the third party software from www.odigo.com is used to detect other web surfers in the same town to initiate chats. Message boards that are linked to many useful predefined categories are used to share and find local information. Systems are also set to overcome a lot of the language barriers between the people in the world to communicate with each other.

### DETAILED DESCRIPTION OF THE INVENTION

At www.hometowninteractive.com (www.hi22.com) it's easy to find and share local information. A system is set for people from each country from around the world to go to any towns quickly. Once at a town the system allows the web surfers to be able to find and share local information easily. As we all know each county has it's own languages, the system can also help people overcome a lot of the language barriers.

This system allows users to be able to surf to a hometown in a few mouse clicks. There are two ways to do this. The first way is to find a town in the world by the natural order of continents, countries, provinces and towns. At www.hi22.com each continent, country, province and town are assigned an English letter and followed by an Arabic number. The English letters are assigned in alphabetical order. A is for continents, B is for countries, C is for provinces, D is for towns, E is for the categories in a town, F is for the sub-categories in a town and so on. This arrangement is clearly indicated on a United States road sign type picture. The English alphabet is chosen because English is the international language and most people from around the world would know the basic a, b, c, d and e of the English alphabet. The Arabic number is chosen because it's international and most people from around the world would know them. Any type of alphabet and numbering system could have been used but the English alphabet and Arabic numeral are the most popular in the world. The second way is to search only one directory in www.hi22.com that contains only very simple web pages with just the name of the town and the URL to the town. This way the search result would be only the links to the towns. On a search result web page the web surfer click once to the simple web page with the name of the chosen town. Then click again on the simple web page with just the name of the chosen town to arrive at the chosen town to interact with the locals.

Once at a chosen town the system allows web surfers to easily find and share local information. The chosen town's homepage clearly indicates the name of the continent, country, province, town, a picture of its national flag and a clock with the local time. Other chosen town's web pages also have the name of the continent, country, province and town and a picture of its national flag. These signs assure a web surfer that he/she is at the correct chosen town. A third party product from www.odigo.com can be used to detect the other web surfers at the same web page. People can easily initiate instant messaging conversations. Another method of showing a web surfer's presence in a certain town is for the web surfer to post his/her contact information such as email or other instant messengers' ID under the category of “e5. Hi, I'm on the web!”. The message postings are time stamped. People can easily contact the web surfer even if the web surfer has surfed away to other parts of the world wide web. Each town's categories are listed in exactly the same way as the continents, countries, provinces and towns with the combination of English alphabet and Arabic numbers. There are many categories in a town. These are the currently available categories:
e1. Hometown Interactive at
e2. Business Interactive
e3. Knowledge Interactive
e4. visitors
e5. Hi, I'm on the web!
e6. local live web cams
e7. Any nice comments for ?
e8. local emergency
e9. local history
e10. local maps
e11. shopping interactive
e12. www search engines
e13. local people
e14. local time
e15. local weather
e16. local radios
e17. local televisions
e18. local newspapers
e19. local sports
e20. local schools
e21. local government
e22. local party time!
e23. stock quotes
e24. world references
e25. local single point of trust
e26. interactive technology center
e27. local movie theaters
e28. local transportation
e29. local hotels
e30. local restaurants
e31. nearby towns
e32. local tourists info
e33. local farming
e34. local environment
e35. looking for someone
e36. hometown photos
e37. local dating
e38. local marriages
e39. local religions
e40. local health
e41. computer questions
e42. local announcements
e43. local entertainment
e44. friends of this town
e45. on sale
e46. houses for sale
e47. cars/motorcycles for sale
e48. items for sale
e49. apartments/houses for rent
e50. housing wanted
e51. engineering careers
e52. business careers
e53. careers
e54. jobs
e55. resumes
e56. job trainings

Each category is linked to a message board except these:
e1. Hometown Interactive at
e11. shopping interactive
e12. www search engines
e23. stock quotes
e24. world references
e25. local single point of trust
e26. interactive technology center.

The message board is a third party software from www.magictree.com/dialogue/dialogue.htm. Any other third party message board software could have been used. This message board does not require a username and a password to use it. This way people can post messages very quickly. The message board can send an email to a response if the web surfer entered an email in the message posting for such a purpose. The message board is set to display any language from around the world. People can view the message board without a username and a password. Finding the local information is easy. Just go to the appropriate category and view the postings in the message board. Sharing the local information is just as easy. Just go to the appropriate category and post your local information. One of the very useful categories in a town is the “e2. business interactive” category. Each business category is linked to a message board. People can post the URL of their business and other information related to their business. There are 4,838 categories under the “e2. business interactive” category. Towns from around the world can range from very large cities to very small towns. Mid-sized and small towns can't use all 4,838 categories. Also the business information is posted as the customers use the business categories. It would be a hassle to look through which 4,838 business categories have postings. The link of “1.______ 2.______ 3.______ list all posted web pages on this Business Interactive” is to display only the business categories that have postings in the message boards. For small towns there is a special web page with just the English alphabet linked to the message boards. Also once a business has been posted and paid a fee. It's business link will be manually placed under the @:-) link. Under the “$:-) e2. Business Interactive” the links for all the posted businesses with paid fees will be posted under this link. This way the locals can find the web pages of the local businesses very quickly. “Hometown links:” allow a web surfer to go all the web pages of one particular town very easily without mistakes. This allows the web surfer to feel comfortable surfing at a chosen town since there are thousands of other towns that's just a mouse click away and the web pages are carbon copy of each other. Once a web surfer is familiar with the categories in his/her hometown then that web surfer can easily go to any other towns in the world and quickly go to the desired predefined categories to find and share local information since the web pages are carbon copies. However, the links for each predefined category to the message boards in all the towns in the world are unique.

As we all know each county has it's own languages, the system can also help people overcome a lot of this language barriers. The main language of www.hi22.com is English since it's the international language of the world. The combination of the English alphabet and Arabic number is easy for people speaking different languages to refer to things on the web pages of www.hi22.com. The English alphabet is listed on many web pages through out www.hi22.com so that people that are not very familiar with the English alphabet can reference to it. The URL to each web page is also referred to by this English alphabet and Arabic number combination. For example, www.hi22.com/a6/b159/c1/d56/ is for Africa, Sudan, All Provinces and Al Qadirif, respectively. If the URL is in the name of the continent, country, province and town then the person you speak to need to understand English well and can spell all the English words for places perfectly. Even college educated native English speakers would misspell many places' name. Misspelled URL is a bad link. Using English letters and Arabic numbers are very easy to refer to places and categories. This way people speaking different languages can communicate with each other easily about places in the world and the predefined categories in www.hi22.com. The English name of the places and category names in www.hi22.com can also be translated to any language in the world. Next to each name of a place and each name of a category there is a link for language translation. The translation web page has a link for each country and each country is linked to a message board that can post messages in any language. The town's categories of each country will have its national language next to the right side of the English category names. This translation need to be web surfers supplied since it's not possible for me to know all the languages in the world. Once the web surfers are familiar to the categories in his/her hometown the system of English letters and Arabic number can easily extend this understanding of the categories in any town in the world. Each town the categories are a copy of each other. They are exactly the same. Any comment or instruction in English has a link for translation for all the languages in the world. The translation for all the languages would have to come from the web surfers that know that particular language and translate them from English. The translation will benefit all the people in his/her country. The translation for the few major languages of the world can be available by linking to a free translation service on the web such as the http://babelfish.altavista.com. This link is provided throughout www.hi22.com's web pages. If there is any need of help of using this web site the web surfer could ask other web surfers by using the web presence instant messenger for real time answer or post a question to the help web page that's accessible by anyone but visited often by the www.hi22.com's technical support.

### BRIEF DESCRIPTION OF THE DRAWINGS

FIG. 1 is the homepage of www.hi22.com.

FIG. 2 is the top third web page for countries of a continent and in this case it's for Africa.

FIG. 3 is the middle third web page for the African countries.

FIG. 4 is the bottom third web page for the African countries.

FIG. 5 is the web page for the provinces of a country and in this case it's for all provinces of Sudan in Africa.

FIG. 6 is the list of town under a province and in this case this list is for all provinces in Sudan, Africa.

FIG. 7 is the top half of homepage of the town Abu Jabirah in Sudan, Africa with the URL of www.hi22.com/a6/b159/c1/d11/.

FIG. 8 is the bottom homepage of the town Abu Jabirah in Sudan, Africa with the URL of www.hi22.com/a6/b159/c1/d11/.

FIG. 9 is the top third web page of the second page of the homepage of the town Abu Jabirah in Sudan, Africa with the URL of www.hi22.com/a6/b159/c1/d11/.

FIG. 10 is the middle third web page of the second page of the homepage of the town Abu Jabirah in Sudan, Africa with the URL of www.hi22.com/a6/b159/c1/d11/.

FIG. 11 is the bottom third web page of the second page of the homepage of the town Abu Jabirah in Sudan, Africa with the URL of www.hi22.com/a6/b159/c1/d11/.

FIG. 12 is the top page of a very long page for the predefined category of “e2. business interactive”.

FIG. 13 is the top frame with the links to many web page of the predefined category of “e2. business interactive”.

FIG. 14 is the top frame of the list web pages for countries, provinces and towns with the pictures showing the hierarchy of continents, countries, provinces and towns.

FIG. 15 is right frame of the list web pages for countries, provinces and towns.

FIG. 16 is the top portion of a sample web page of a translation web page for all the names of the continents, countries, provinces, towns, predefined categories, comments and instructions.

FIG. 17 is sample web page with links to getting more quick information on a country.

### DETAILED DESCRIPTION OF THE DRAWINGS

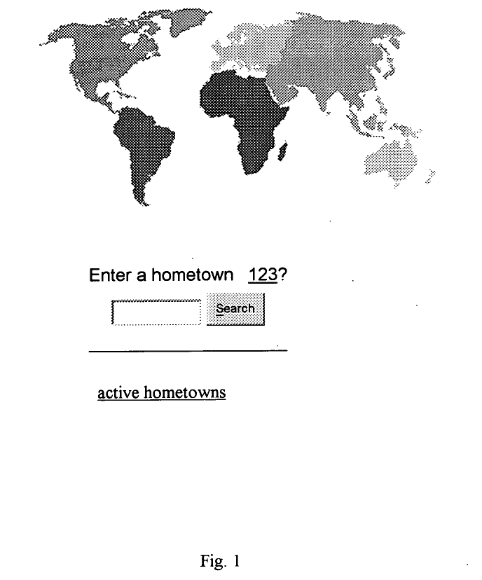

FIG. 1 is the homepage of www.hi22.com. This simple homepage has two ways for a web surfer to arrive at a chosen town in the world. The first method is to search by entering a town. The search will be done on only www.hi22.com/hometownsearch/ directory. This directory contains very simple web pages with just the name of a town and the URL to the town for all the available towns in www.hi22.com. This first method obviously requires the web surfer to spell out the name of the town in English correctly. That can be a challenge sometimes. The second method is to go through the lists of continents, countries, provinces and towns to arrive at a chosen town. The homepage shows a world map divided into six continents and the world map is differentiated by various distinct colors. The first six figures show an example of arriving at a town with the lists of continents, countries, provinces and towns. At this time suppose a web surfer has clicked on the continent of Africa at FIG. 1.

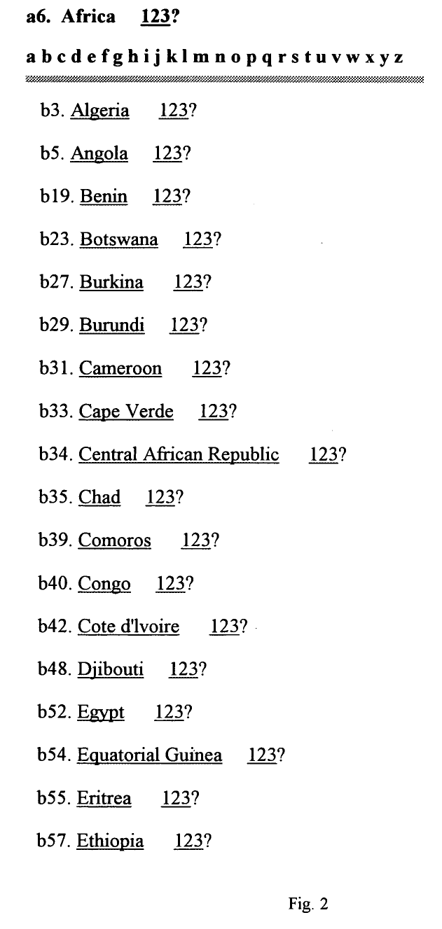

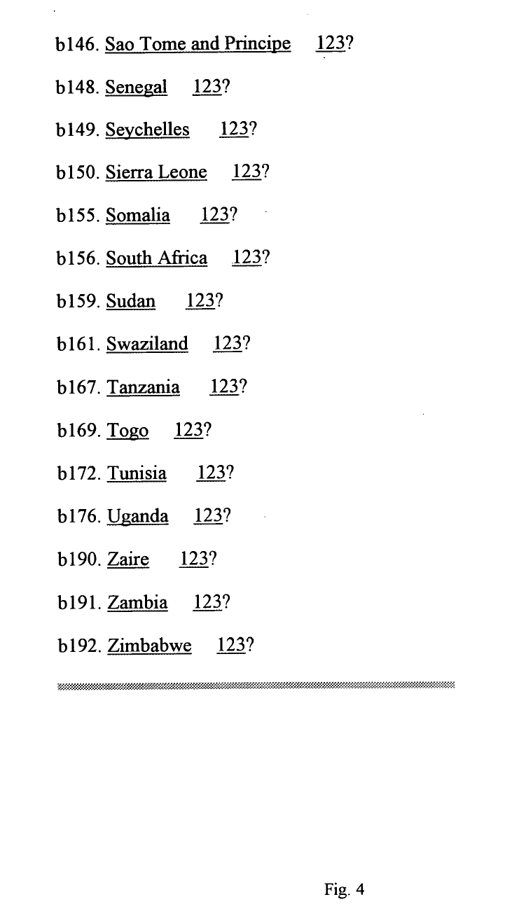

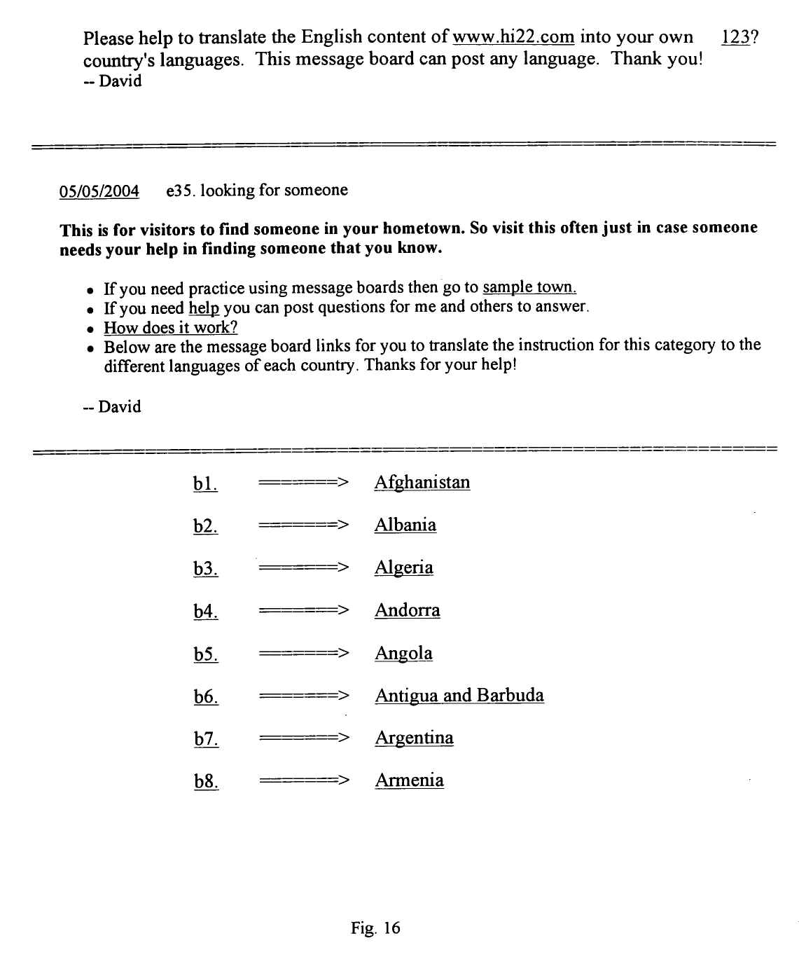

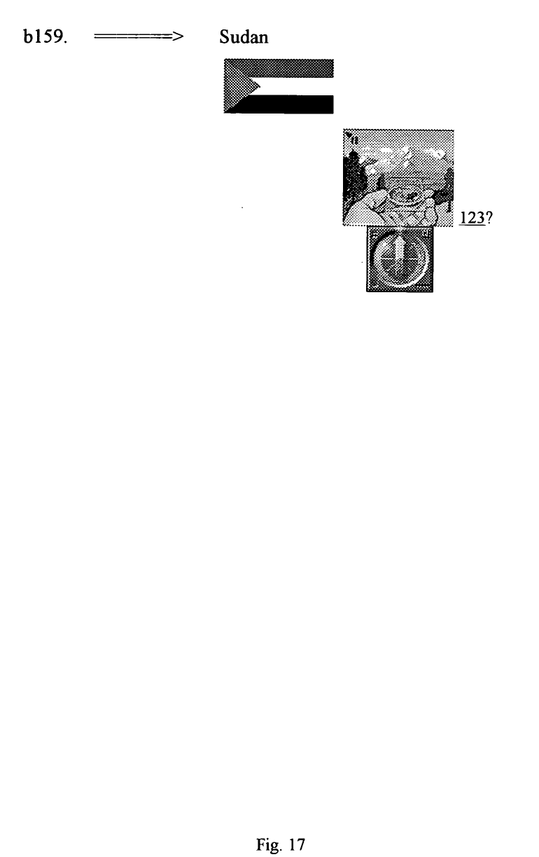

FIG. 2 is the top third web page for the countries of a continent and in this case it's for Africa. The web surfer that clicked on the African continent on the world map at FIG. 1 would have arrived at FIG. 2. All the African countries are listed. Each country is assigned the English letter “b” and an Arabic number. The Arabic number was assigned when all the countries in the world were listed alphabetical order in English then the countries were listed to its respective continents. On the right side of each country there is a “123?”. The “123?” is a link for translation into all the languages in the world to the English term that it's next to. The detail is shown on FIG. 16 and FIG. 17. The English alphabet is clearly shown. This is for people in the world that don't know the English alphabet that well for easy reference. This type of display of English alphabet is shown on many web pages on www.hi22.com. Now suppose the web surfer has clicked on “b159. Sudan” on FIG. 4.

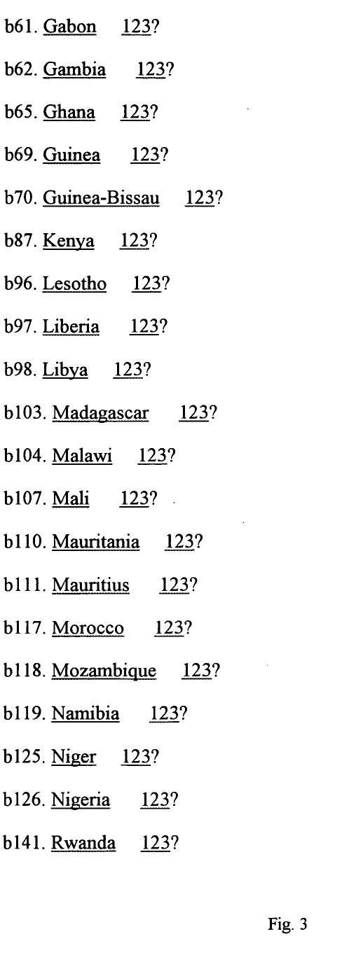

FIG. 3 is the middle third web page for the African countries.

FIG. 4 is the bottom third web page for the African countries.

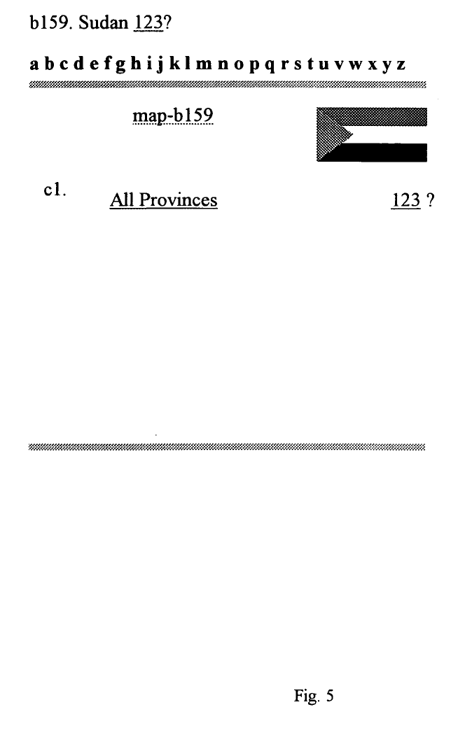

FIG. 5 is the web page for the provinces of a country and in this case it's for all provinces of Sudan in Africa. The web surfer that clicked on “b159. Sudan” at FIG. 4 would have arrived at FIG. 5. A small Sudan's flag is shown. A “map” link is there for more quick information on a country from www.mapquest.com. This is done for all the countries. For a small country it is more practical to list all the towns at once. That's why there is “All Provinces” link. For a large country like the Canada all the provinces would be listed. The towns would be under its respective provinces. Now suppose the web surfer has clicked on “c1. All Provinces” at FIG. 5.

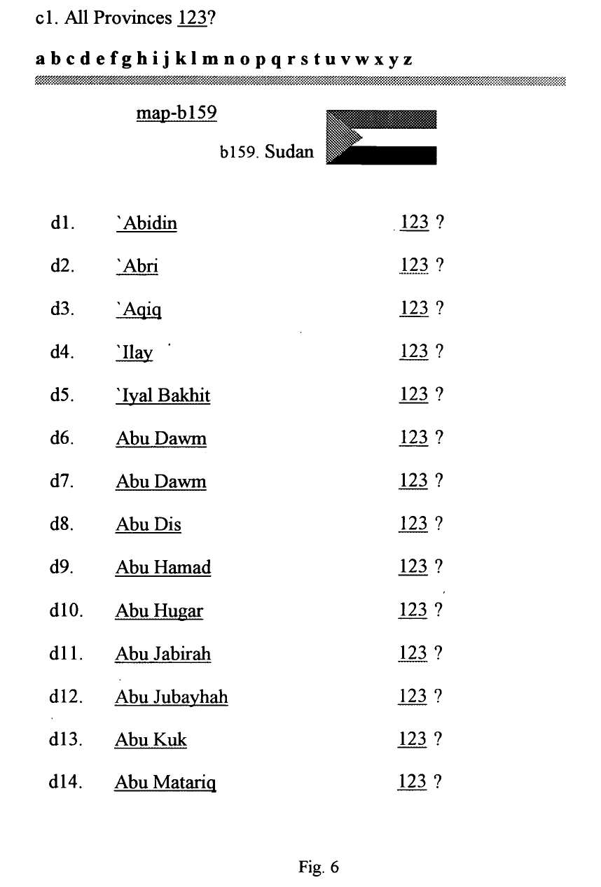

FIG. 6 is the list of towns under a province and in this case this list is for all provinces in Sudan, Africa. The web surfer that clicked on “c1. All Provinces” at FIG. 5 would have arrived at FIG. 6. This list lists all the big and small towns in Sudan. Now suppose the web surfer has clicked on “d11. Abu Jabirah” at FIG. 6.

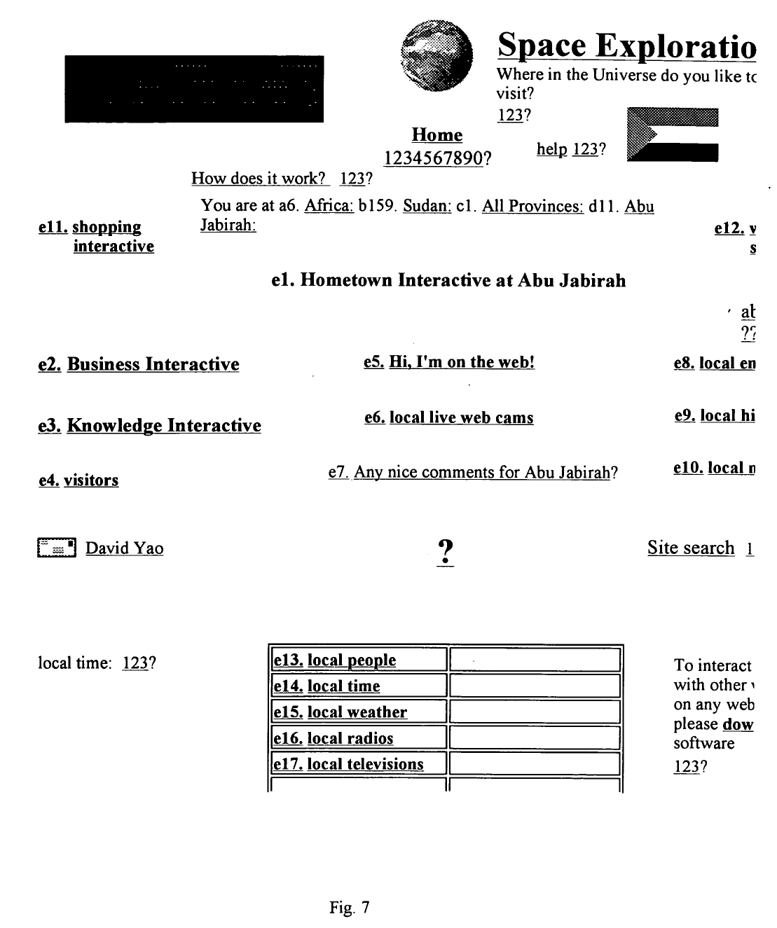

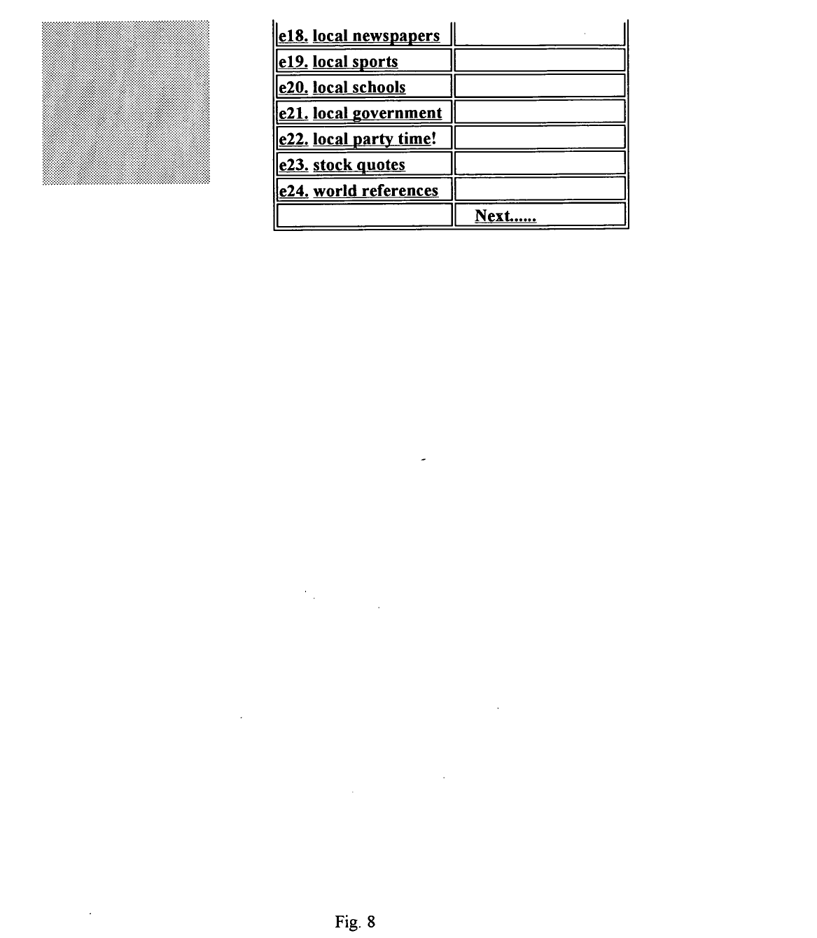

FIG. 7 is the top half of homepage of the town Abu Jabirah in Sudan, Africa with the URL of www.hi22.com/a6/b159/c1/d11/. The web surfer that clicked on “d11. Abu Jabirah” at FIG. 6 would have arrived at the homepage of the chosen town, Abu Jabirah, at FIG. 7. The homepage also include FIG. 8. There are clear signs that you have arrived at Abu Jabirah such as “You are at a6. Africa: b159. Sudan: c1. All Provinces: d11. Abu Jabirah:”, “e1. Hometown Interactive at Abu Jabirah”, a clock with local time and the Sudan's national flag. This web site is designed for web surfers to interact with the locals of a town and all other web surfers on www.hi22.com. The web surfer can download the web presence instant messenger from www.odigo.com. After a quick installation the web surfer can see other web surfers at the town of Abu Jabirah or all the web surfers at www.hi22.com. The web surfer could initiate a conversation or other web surfers could start a conversation with the web surfer. The web surfer can easily find local information. Just go to the predefined category of interest and click on it. The link would have directed the web surfer to a message board just for that predefined category of interest. If there is already local information posted then the web surfer can read them. If the web surfer didn't find the interested local information then the web surfer can easily post a question for his/her interested local information. An email address can be included in the posted question. The email address will be known only to message board software. It's not shown anywhere in the posted messages. When a response is available then an automatic email is send to the provided email address. The email would include a link back to the message board that had posted the question. The web surfer can easily come back to the message board that he/she had posted the question just by clicking the link provided in the email from www.hi22.com's message board. Hopefully the response has the interested local information. It works all the same way for the predefined categories. Some of the predefined categories list more predefined sub-categories. Those categories would have links to its message boards. Other predefined categories would link to other useful information. It is for the web surfers to look through all the useful predefined categories that I have thought up and see if they are of interest to them.

FIG. 8 is the bottom homepage of the town Abu Jabirah in Sudan, Africa with the URL of www.hi22.com/a6/b159/c1/d11/. It just lists more useful predefined categories. If the web surfer needs any help he/she can ask other web surfers with the web presence instant messenger or go the help link and post the questions. The help web page is accessible by anyone and visited often by the www.hi22.com's technical support. Now suppose the web surfer has clicked on the “Next” link at FIG. 8.

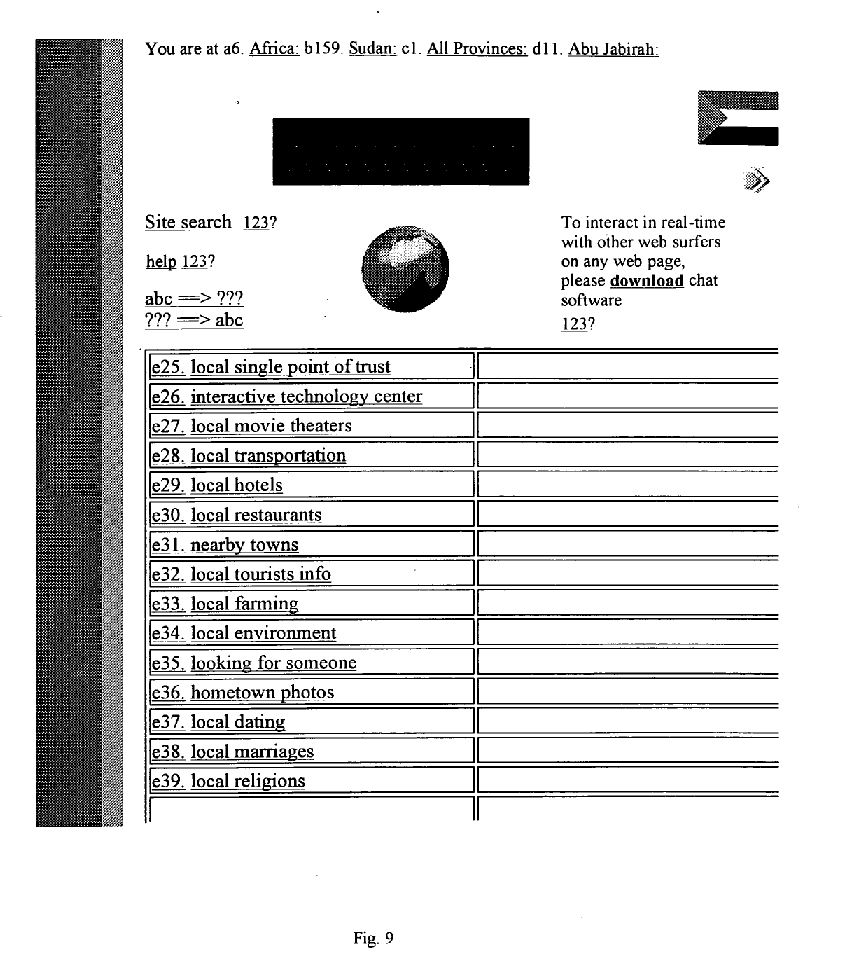

FIG. 9 is the top third web page of the second homepage of the town Abu Jabirah in Sudan, Africa with the URL of www.hi22.com/a6/b159/c1/d11/. The web surfer that clicked the “Next” link at FIG. 8 would have arrived at FIG. 9. This web page list more useful predefined categories. Many helpful links are provided. “hometown links:” is for links to all the web pages in one town, in this case it's Abu Jabirah. “abc===>??????===>abc” is a link to a free translation service for the world's major languages such as http://babelfish.altavista.com.

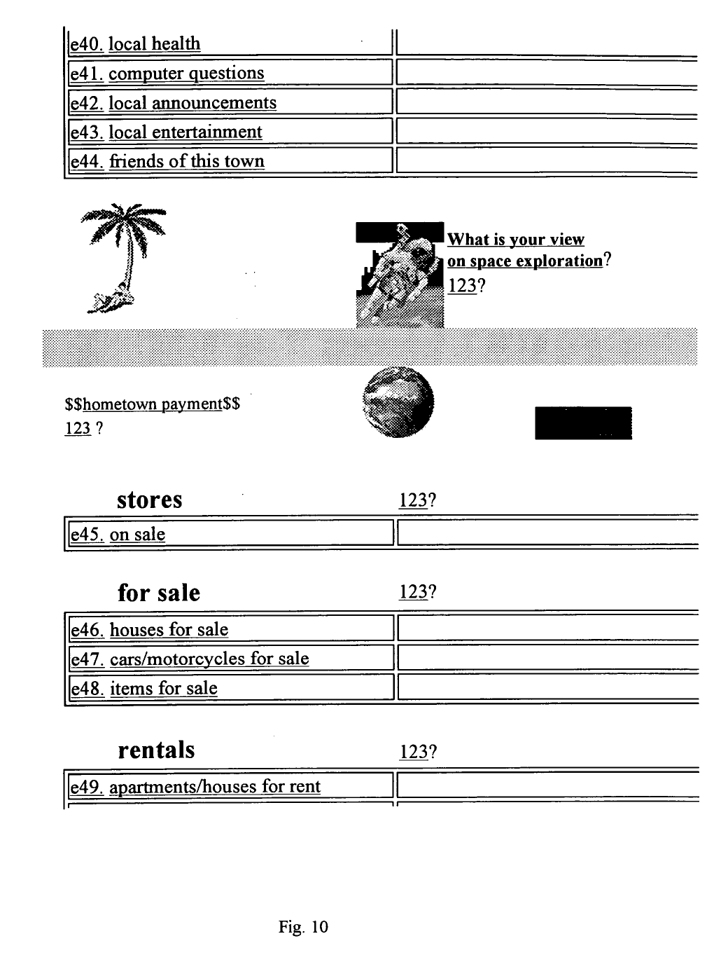

FIG. 10 is the middle third web page of the second homepage of the town Abu Jabirah in Sudan, Africa with the URL of www.hi22.com/a6/b159/c1/d11/. This is just more listing of the useful predefined categories.

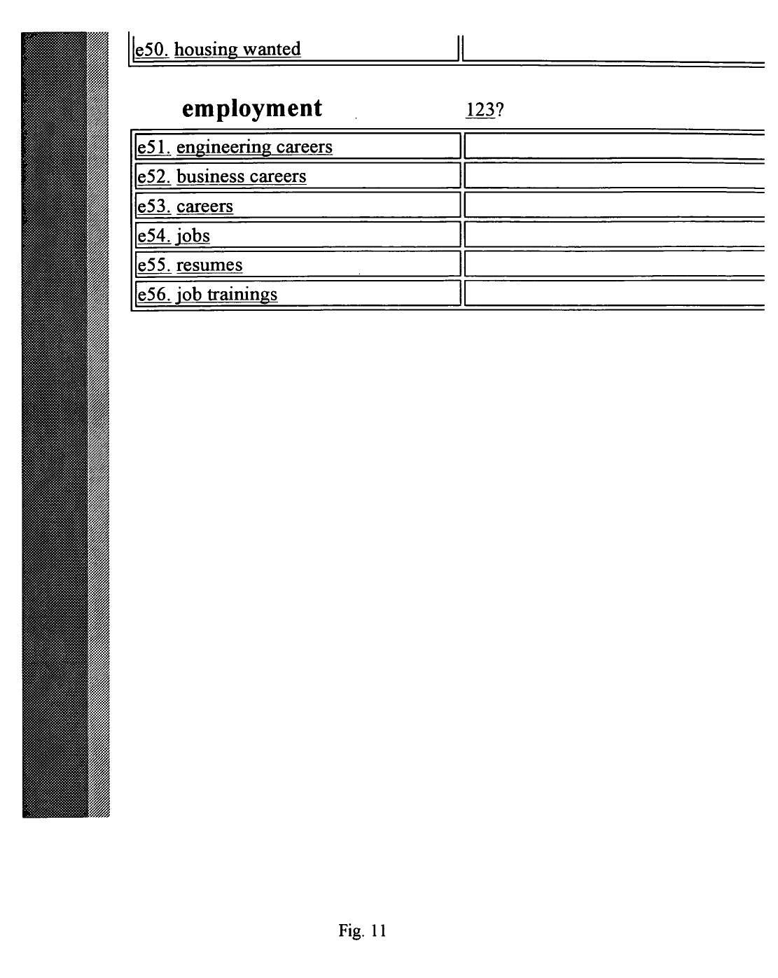

FIG. 11 is the bottom third web page of the second homepage of the town Abu Jabirah in Sudan, Africa with the URL of www.hi22.com/a6/b159/c1/d11/. This is just more listing of the useful predefined categories.

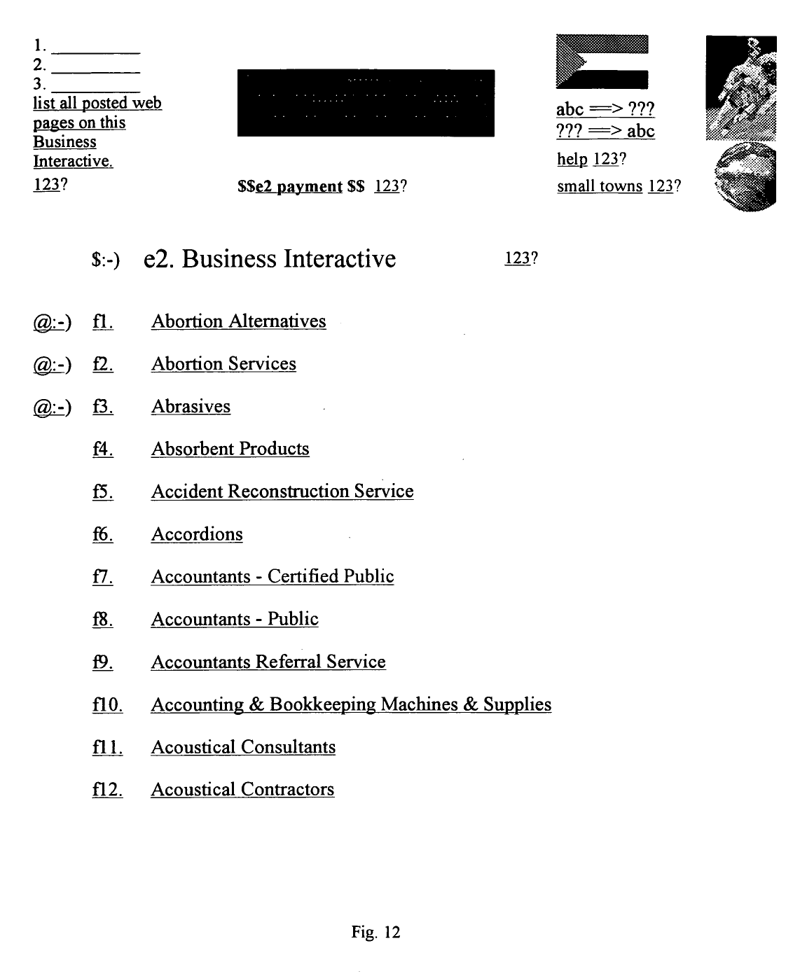

FIG. 12 is the top web page of a very long web page for the predefined category of “e2. business interactive”. If the web surfer had clicked “e2. Business Interactive” at FIG. 7 or had clicked “d11/e2” under “hometown links:” on FIG. 9 would have arrived at FIG. 12. This category has 4,838 subcategories that are related to different types of businesses. Each business sub-category is linked to a message board and works the same way that has been described in FIG. 7. A fee is required to post in these business categories. Once it's paid then the posted business information is put on a web page that's linked under the “@:-” link. Under the “$:-) e2. Business Interactive” links for all the posted businesses with paid fees will be posted under this link. The link of “1.______ 2.______ 3.______ lists all posted web pages on this Business Interactive” is to displaying only the business categories that have postings on the message boards. For small towns there is a special web page with just the English alphabet linked to the message boards and this web page is linked from “small town” at FIG. 12 and the rest of the d11/e2. These ways of presenting of all available posted businesses allow the locals to find the web pages of the local businesses very quickly.

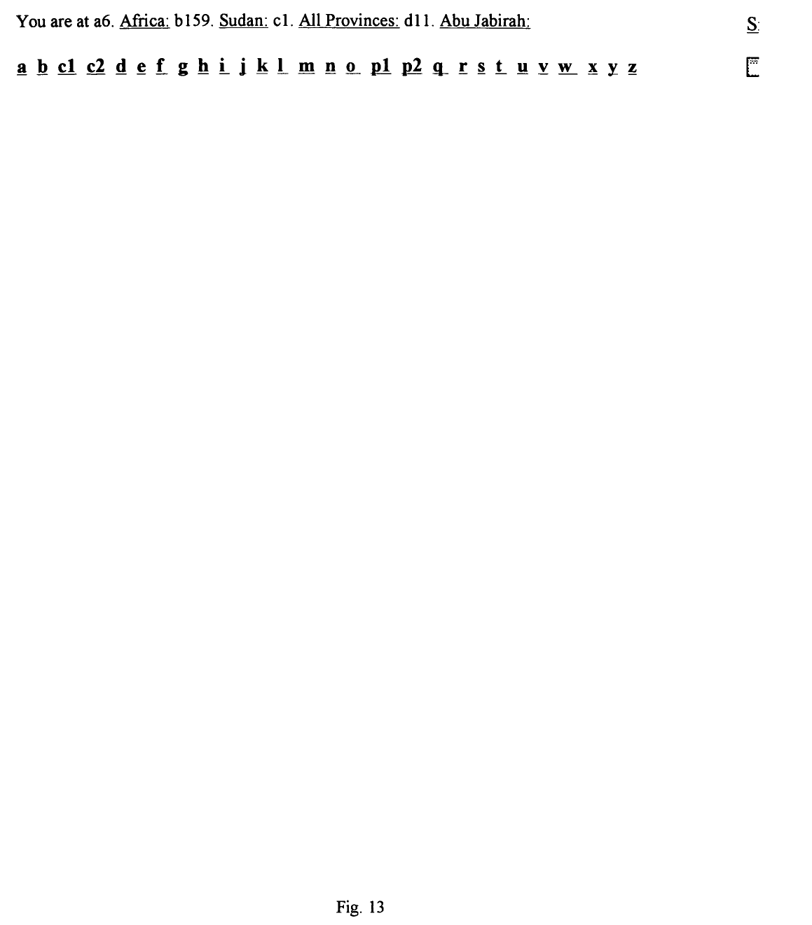

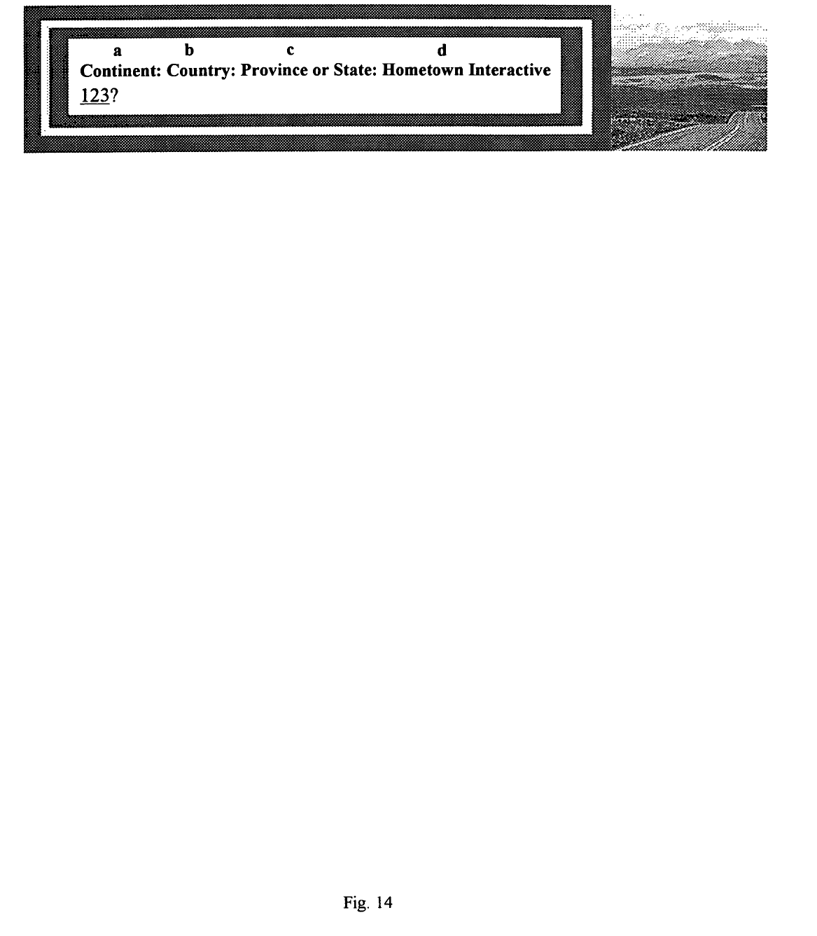

FIG. 13 is the top frame with the links to many web page of the predefined category of “e2. business interactive”. The English letters are the links to all the business categories. FIG. 14 is the top frame of the list web pages for countries, provinces and towns with the pictures showing the hierarchy of continents, countries, provinces and towns. This picture shows the web surfers that a is for continents, b is for countries, c is for provinces and d is for towns.

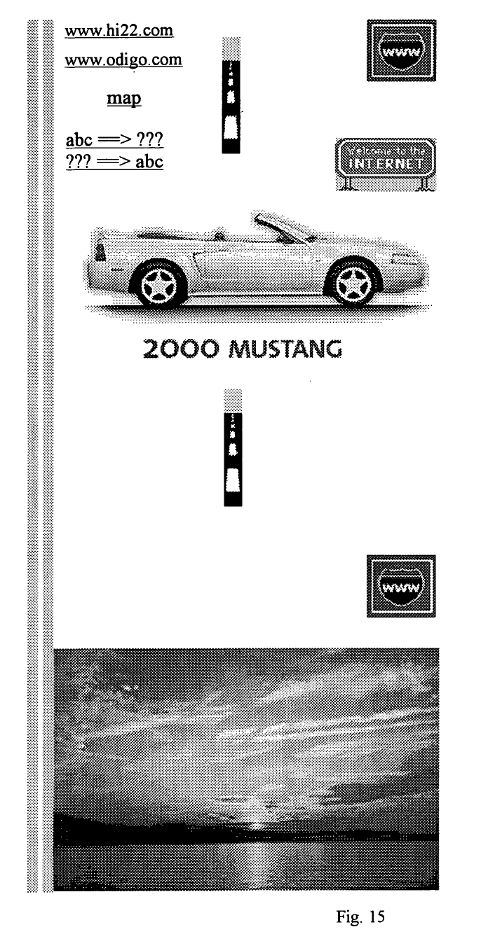

FIG. 15 is right frame of the list web pages for countries, provinces and towns. It depicts a road with road markings, road signs and car.

FIG. 16 is the top portion of a sample web page of a translation web page for all the names of the continents, countries, provinces, towns, predefined categories, comments and instructions. The English words that need to translate to other languages are shown. On the left side of the list is the letter “b” with a number. Each of them correlate to a country and the country's name is shown on the right. The letter “b” with a number links to a message board and the name of a country links to FIG. 17.

FIG. 17 is a sample web page with links to getting more quick information on a country. The national flag links to a larger version of the same flag. The picture of mountain and compass links to the quick information of a country on www.mapquest.com.

What I claim as my invention is:

1. A system of web pages designed for web surfers in a few mouse clicks to arrive at a chosen town in the world and the system comprising:
a hierarchy of continents, countries, provinces, towns and predefined categories; and
a combination of an English alphabet and an Arabic numeral assigned to each said continent, said country, said province, said town and said predefined category.

2. The system of claim 1, wherein the URL to each said continent, said country, said province, said town and said predefined category is a direct correlation of the assigned combination of a said English alphabet and a said Arabic numeral. The said English alphabet is chosen because English is the international language and most people from around the world would know the basic a, b, c, d and e of the said English alphabet. The said Arabic numeral is chosen because it's international and most people from around the world would know them. Any type of alphabet and numbering system could have been used but the said English alphabet and said Arabic numeral are the most popular in the world.

3. A search for said towns in the world on a single directory that consists of only simple web pages containing only the name of the claim 1 said town, said province, said country and the said URL of claim 2 to the said town.

4. At a said town a web surfer can easily find and share local information through the means of said predefined categories linked to unique unicode message boards such as the third party software the dialogue from www.magictree.com/dialogue/dialogue.htm and of a web presence instant messenger such as the third party software from www.odigo.com to detect the presence of other web surfers on the same web page to initiate chats.

5. Each said continent, said country, said province, said town and said predefined category have a link to a web page consisting a list of the world's said countries with a link to an unicode said message board for each said country for translation of all the languages in the world.

6. Each said town has the said predefined category of“e5. Hi, I'm on the web!” with a link to a said message board. Web surfers' contact information such as instant messenger ID or email can be posted for others to contact the particular web surfer as that web surfer has surfed to other parts of the world wide web. The posting of said contact information is time stamped on the said message board.
